(19) United States
(12) Patent Application Publication
(10) Pub. No.: US 2013/0003170 A1
(43) Pub. Date: Jan. 3, 2013

(54) POSITIONING UNIT AND MONITORING DEVICE

(75) Inventors: Carsten Feiertag, Hungen (DE); Guenter Pfeiffer, Gladenbach (DE); Rainer Kirchhuebel, Asslar (DE)

(73) Assignee: OCULUS OPTIKGERAETE GMBH, Wetzlar-Dutenhofen (DE)

(21) Appl. No.: 13/354,743

(22) Filed: Jan. 20, 2012

(30) Foreign Application Priority Data
Jan. 20, 2011 (DE) 10 2011 002 940.0

(51) Int. Cl. G02B 21/00

(52) U.S. Cl. 359/368

(57) ABSTRACT

A positioning unit for positioning an optical unit (12, 13) comprising at least one optical element in a beam path (20) of a microscope between an objective lens of a microscope and in front of an eye to be monitored is provided, wherein the positioning unit comprises a connection device (21), wherein the connection device (21) can couple the positioning unit can be coupled to the microscope, wherein the positioning unit is formed, at least in part, of plastics material. The invention also relates to a monitoring device (10) comprising a positioning unit (11).

This application claims priority from German Patent Application No. DE 10 2011 002 940.0, filed Jan. 20, 2011, the entire disclosure of which is incorporated herein by reference.

### FIELD OF THE INVENTION

The invention relates to a positioning unit for positioning an optical unit comprising at least one optical element in a beam path of a microscope between an objective lens of a microscope and in front of an eye to be monitored, wherein the positioning unit comprises a connection device by means of which the positioning unit can be coupled to the microscope.

### BACKGROUND OF THE INVENTION

Microscopes for carrying out eye operations are regularly used for operations in a front area of an eye. Should such interventions be undertaken in a rear area of an eye, it is necessary to supplement the microscope with a monitoring device, which makes it possible to focus on precisely this area of the eye. Such monitoring devices comprise at least one wide angle lens or ophthalmoscopy lens for wide-angle examination of the relevant rear part of the eye, wherein the ophthalmoscopy lens provides an intermediate image in a beam path in front of an objective lens of the microscope. This intermediate image cannot be focussed with the microscope. Depending on the focal length of the auxiliary optics and of the examined eye, the intermediate image appears sharp in a position that lies closer to the object. To focus the intermediate image, it is necessary to shorten the focal length of the microscope object. A height adjustment of the microscope does not change the focal length. By using a reducing lens in the beam path beneath the microscope object, the plane of the intermediate image may lie in the focus of the microscope. In order to focus this intermediate image using the microscope, the microscope has to be moved or spaced in relation to the ophthalmoscopy lens over a distance. This change in height is basically determined by the individual refractive power of the eye and by the different refractive power of the selected ophthalmoscopy lens.

The two lenses are held by a positioning unit of the monitoring device, which is fixed directly on the microscope, and, if necessary, they can be positioned in the beam path without the need for considerable adjustment of the microscope during an operation. The positioning unit generally comprises a connection device, by means of which the positioning unit can be coupled to the microscope. The positioning unit is also formed in such a way that the relevant lens can be easily pivoted or slid into the beam path and removed therefrom again.

In order to adapt the intermediate image of the ophthalmoscopy lens as precisely as possible to a focal length of the microscope objective lens, at least one of the lenses is designed to be adjustable along the beam path of the microscope. In known monitoring devices, a linear guide is provided on the positioning unit, for example, for adjustment of the lens in a longitudinally displaceable manner, wherein the lens can be moved by means of an adjusting wheel having a screw drive. In order to prevent an accidental collision between the ophthalmoscopy lens and the eye or to avoid possible damage to the eye during an operation, the positioning unit is formed in such a way that the ophthalmoscopy lens is movable, essentially without resistance, in the direction of the objective lens of the microscope, that is to say it can move back in the event of a collision with the eye. For example, this is achieved by a second linear guide, which also enables a longitudinal displacement of the ophthalmoscopy lens.

In addition to the above-described mechanical and optical requirements, it is important that the monitoring device and the positioning unit are basically sterile during an operation, so as to prevent a possible infection of an eye with germs, for example. In particular, there is a risk of infection since the monitoring device is advanced relatively tightly against the eye in question during an operation. The possibility of an infection of the patient's eye by an insufficiently prepared positioning unit is ruled out by use of a disposable positioning unit, supplied in a sterile state. It is therefore usual to sterilise the monitoring device and positioning unit in question before an operation, for example, by steam sterilisation. To carry out repeated sterilisation, it is absolutely necessary to form all components of the monitoring device and positioning unit, except for any seals made of resilient materials such as rubber, from metal or glass. Other materials, such as plastics materials have not proven to be very durable for repeated sterilisation. The linear guides and the screw drive also have to be formed in a dimensionally accurate manner to ensure specific fits, and, therefore, only components made of metal are also considered in this instance. To prevent an infiltration of water into the guides during the sterilisation, these can be provided with rubber seals or seals made of other resilient materials. It is also necessary to lubricate corresponding pairs of sliding surfaces of the guides and of the screw drive at regular intervals using a lubricant so as to ensure the function thereof.

The monitoring devices and positioning units known from the prior art pose a range of drawbacks. A weight of the monitoring device, which can be adapted, for example, to an adapter plate on the microscope screwed onto the microscope, is therefore relatively high and disruptive in the event of handling of the monitoring device during an operation. The linear guides can also only be sealed or sterilised with difficulty. During steam sterilisation, water or steam can only infiltrate the screw paths of the screw drive with difficulty, and, therefore, undesired water residues or germs may still remain in the screw paths after the steam sterilisation. It is also disruptive that the lubricants used are removed, at least in part, during the steam sterilisation and contaminate the water used for sterilisation. The sterilisation process itself is also to be considered problematic since it cannot be ruled out with absolute certainty that germs will still remain on the monitoring device and on the positioning unit after the steam sterilisation. The quality of a sterilisation process is therefore also dependent, inter alia, on water quality in a steam sterilisation apparatus.

Furthermore, a monitoring device and a positioning unit are to be sterilised after each use, and, therefore, the monitoring device and positioning unit cannot be used directly after use in subsequent eye operations owing to the sterilisation times. As the case may be, it is necessary to obtain and have available a plurality of monitoring devices and positioning units so that operations can be carried out without any time restraint. High overall costs for production, sterilisation and maintenance of the monitoring device and positioning unit are thus sustained by a user, as well as costs incurred owing to increased capital investment.

The object of the present invention is, therefore, to propose a positioning unit and a monitoring device of which the production costs are reduced to such an extent that resterilisation can be omitted.

### SUMMARY OF THE INVENTION

This object is achieved by a positioning unit having the features of a first embodiment and a monitoring device having the features of an eleventh embodiment. More specifically, in accordance with the first embodiment of the present invention, a positioning unit (11, 60) for positioning an optical unit (12, 13) comprising at least one optical element in a beam path (20) of a microscope between an objective lens of the microscope and in front of an eye to be monitored is provided, wherein the positioning unit comprises: (a) a connection device (21, 61), by means of which the positioning unit can be coupled to the microscope, characterised in that the positioning unit is formed, at least in part, of plastics material. In accordance with a second embodiment of the present invention, the first embodiment is modified so that the positioning unit (11, 60) further comprises: (b) a positioning device (22), by means of which the optical element is movable relative to the microscope in the longitudinal direction of the beam path (20). In accordance with a third embodiment of the present invention, the second embodiment is modified so that the positioning unit is formed of a first double rocker mechanism (31, 64) and a second double rocker mechanism (32, 65), wherein the double rocker mechanisms are interconnected by means of a common coupling member (33, 72). In accordance with a fourth embodiment of the present invention, the third embodiment is further modified so that link brackets of the double rocker mechanisms (31, 32) are formed in each case by a living hinge (36).

In accordance with a fifth embodiment of the present invention, the second embodiment, the third embodiment, and the fourth embodiment are further modified so that the positioning device (22) comprises an adjustment means (46), by means of which a position of the optical element is adjustable. In accordance with a sixth embodiment of the present invention, the second embodiment, the third embodiment, the fourth embodiment, and the fifth embodiment are further modified so that the positioning device (22) forms a safety means (56) which allows a loose movement of the optical element if a force is exerted on the optical element in the direction of the microscope. In accordance with a seventh embodiment of the present invention, the second embodiment, the third embodiment, the fourth embodiment, the fifth embodiment, and the sixth embodiment are further modified so that the positioning unit (11) comprises an alternating device (23), by means of which the optical element can be moved into and out of the beam path (20). In accordance with an eighth embodiment of the present invention, the seventh embodiment is further modified so that the alternating device (23) is formed by the connection device (21) and the positioning device (22) in such a way that the positioning device is pivotable relative to the connection device.

In accordance with a ninth embodiment of the present invention, the seventh embodiment or the eighth embodiment is further modified so that the alternating device (23) is formed as a hinge, and the alternating device comprises at least one snap-in means (28, 29), by means of which the optical element is lockable in a use position in the beam path (22) and/or in an idle position outside the beam path. In accordance with a tenth embodiment of the present invention, the first embodiment, the second embodiment, the third embodiment, the fourth embodiment, the fifth embodiment, the sixth embodiment, the seventh embodiment, the eighth embodiment, and the ninth embodiment, are further modified so that the positioning unit (11) is formed completely of plastics material.

In accordance with the eleventh embodiment of the present invention, a monitoring device (10, 59) is provided that comprises (i) a positioning unit (11, 60) according to any one of the first embodiment, the second embodiment, the third embodiment, the fourth embodiment, the fifth embodiment, the sixth embodiment, the seventh embodiment, the eighth embodiment, the ninth embodiment, and the tenth embodiment, and (ii) at least one optical unit (12, 13), wherein the optical unit comprises at least one optical element. In accordance with a twelfth embodiment of the present invention, the eleventh embodiment is modified so that the positioning unit (11, 60) further comprises a receiving device (19, 55, 63), by means of which the optical unit can be adapted to the positioning unit, wherein the optical unit forms a holding means (16) for holding the optical element and connecting it to the receiving device. In accordance with a thirteenth embodiment of the present invention, the eleventh embodiment is further modified so that the positioning unit (60) forms a holding means (62) for holding the optical element. In accordance with a fourteenth embodiment of the present invention, the twelfth embodiment or the thirteenth embodiment are further modified so that the holding means (16) and/or the receiving device (19, 55, 63) and/or a connection device (21, 61) comprises at least one connecting element (57), which is formed in such a way that it is destroyed upon separation of the holding means and receiving device and/or connection device and a microscope. In accordance with a fifteenth embodiment of the present invention, the eleventh embodiment, the twelfth embodiment, the thirteenth embodiment and the fourteenth embodiment are further modified so that the optical unit (12, 13) is formed of plastics material.

In accordance with a sixteenth embodiment of the present invention, the eleventh embodiment, the twelfth embodiment, the thirteenth embodiment, the fourteenth embodiment, and the fifteenth embodiment, are further modified so that the optical unit (13) is formed in one piece. In accordance with a seventeenth embodiment of the present invention, the eleventh embodiment, the twelfth embodiment, the thirteenth embodiment, the fourteenth embodiment, the fifteenth embodiment, and the sixteenth embodiment, are further modified so that the optical element is formed as an ophthalmoscopy lens (15), which is used to monitor an ocular fundus. In accordance with an eighteenth embodiment of the present invention, the eleventh embodiment, the twelfth embodiment, the thirteenth embodiment, the fourteenth embodiment, the fifteenth embodiment, the sixteenth embodiment, and the seventeenth embodiment, are further modified so that the optical element is formed as a reducing lens, which is used to adjust the beam path.

The positioning unit, according to the invention, for positioning an optical unit comprising at least one optical element in a beam path of a microscope between an objective lens of the microscope and in front of an eye to be monitored comprises a connection device, by means of which the positioning unit can be coupled to the microscope, wherein the positioning unit is formed, at least in part, of plastics material.

In particular, since the positioning unit is formed at least in part of plastics material, the production costs for the positioning unit can be reduced considerably. Essential components of the positioning unit, which are absolutely necessary for mechanical function, can thus be produced in a cost-effective manner, for example, in an injection moulding process. The cost saving attainable by the use of plastics material makes it possible to dispense completely with a reuse of the positioning unit, and to dispose of the positioning unit after one use. Further cost advantages are thus provided, since no costs are incurred for preparation and maintenance. Owing to the disposable use of the positioning unit, contamination risks associated with the sterilisation process and possible defects in the positioning unit can also be excluded. On the whole, as many components of the positioning unit as possible, as well as components that are expensive to produce, are to be formed from one plastics material. The positioning unit is thus designed in the manner of a sterile disposable article, for example, which can be supplied in a protective packaging. Since a reuse or sterilisation of the positioning unit no longer has to be considered, a particularly cost-effective plastics material may be used. A positioning unit designed in such a way can be used in particular if, owing to specific hygiene provisions, a use of re-sterilised instruments is forbidden. There are also no waiting times for eye operations as a result of instruments undergoing the sterilisation process.

In one embodiment, the positioning unit may comprise a positioning device, by means of which the optical element is movable relative to the microscope in the longitudinal direction of the beam path. Movability of the optical element in the longitudinal direction of the beam path makes it possible to adjust the optical unit to the eye to be monitored, and/or to adjust the beam path of the microscope to an intermediate image located in the beam path, without having to make these adjustments on the microscope.

The positioning device may also be formed of a first double rocker mechanism and a second double rocker mechanism, wherein the double rocker mechanisms can be interconnected by means of a common coupling member. The double rocker mechanisms may each be formed of two rod-like rockers, which are each connected, in turn, at their ends to a pivot bearing. Movement of the first double rocker with the coupling member in a circular arc-shaped manner is thus enabled, wherein the second double rocker can likewise move in a circular arc-shaped manner in the same direction, in such a way that a linear movement in the longitudinal direction of the beam path is produced from both circular arc-shaped movements. Owing to this combination of two double rocker mechanisms, it is possible to dispense completely with a linear guide for moving the optical element. The double rocker mechanisms may be formed with single pivot points or pivot bearings, which are substantially easier to sterilise or seal compared to linear guides. In addition, no specific maintenance or lubrication of the double rocker mechanisms is required, and there is no need to produce specific guides having correspondingly narrow tolerances. The rockers of the double rocker mechanisms, as well as the coupling member, can be produced in this instance from a plastics material, for example. It is also conceivable to form the pivot bearing, required for the connection, of plastics material. On the whole, a production cost for the positioning unit can thus be considerably reduced.

In order to ensure a reliable guide of the optical element in the longitudinal direction of the beam path, the first double rocker mechanism can be connected to the second double rocker mechanism via a toothed gearing in such a way that a movement of the first double rocker mechanism can be transferred to the second double rocker mechanism by means of the toothed gearing. To form the toothed gearing, it may be sufficient for at least one tooth of one of the double rocker mechanisms to be engaged with a tooth pair of the other double rocker mechanism. The respective teeth can be formed in the extension of a rocker of the double rocker mechanisms. The toothed gearing and, therefore, a coupling of movement between the two double rocker mechanisms can thus be produced in a particularly simple and cost-effective manner. If the rockers of the double rocker mechanisms are formed of plastics material, then the toothed gearing may easily be moulded integrally on the respective rockers.

In particular, with use of an injection moulding process to produce the double rocker mechanisms, the double rocker mechanisms and the toothed gearing may be formed in one piece. For example, the toothed gearing may be formed between two rockers, which form the necessary teeth in each case. The teeth may be moulded integrally on the rockers, or may be formed by an extension of ends of the rockers. A one-piece design may be facilitated, in particular, since the double rocker mechanisms and the toothed gearing are formed basically in a two-dimensional plane. Such plastics material parts can be produced in an injection moulding process in a particularly simple manner.

It is particularly advantageous if the toothed gearing has a gear ratio of 1:1. A uniform and coincident movement of the double rocker mechanisms can thus be enabled with basically coincident lengths thereof, wherein this movement ensures a linear relative movement of the optical element in the longitudinal direction of the beam path.

Furthermore, a first double rocker of the first double rocker mechanism may be mounted on a connecting bearing member, and a second double rocker of the second double rocker mechanism may be mounted on a receiving bearing member. The connecting bearing member and the receiving bearing member may thus interconnect each of the two rockers of the double rocker mechanisms at a defined distance. The connecting bearing member may thus be provided for rigid fastening in the area of the microscope, wherein the coupling member is movable relative to the connecting bearing member, and the receiving bearing member is movable relative to the coupling member and to the connecting bearing member. The optical element and the optical unit may thus be provided in the area of the receiving bearing member. Both the connecting bearing member and the receiving bearing member may be formed from a plastics material, similarly to the double rockers and the coupling member.

Pivot bearings or link brackets of the double rocker mechanisms can be formed in a particularly simple manner by a living hinge in each case. In particular, if the double rocker mechanisms are formed completely of plastics material, this is particularly advantageous, since all components of the double rocker mechanisms can thus be produced in an injection moulding process together with the link brackets moulded integrally thereon. Furthermore, the assembly of the double rocker mechanisms, which is otherwise necessary, can thus also be dispensed with completely.

In order to move the optical element relatively along the beam path, the positioning device may comprise an adjustment means, by means of which a position of the optical element is adjustable. It can thus be ensured that the optical element is located in the desired position in each case, wherein the adjustment or positioning of the optical element may take place manually, for example, by an operator.

The adjustment means may be formed, for example, of at least one adjusting wheel having a worm gear or an eccentric gear. In one embodiment, the adjusting wheel can thus be mounted on the connecting bearing member and may act on a rocker of the first or second double rocker mechanism by means of a screw moulded integrally on the adjusting wheel. A rotation of the adjusting wheel then changes the distance of the rocker relative to the adjusting wheel depending on which area of the screw is engaged with the rocker. The resultant movement of the rocker consequently leads to a movement of both double rocker mechanisms and, therefore, to a longitudinal movement of the optical element. Such an adjustment means may also be produced from a plastics material in a particularly simple manner. For example, the adjusting wheel with the screw can be produced as an injection-moulded part, which can be easily fitted on a hub. In order to enable operation on either side, two mutually opposed adjusting wheels may also be provided.

To protect an eye against an accidental collision with the optical element, the positioning device may form a safety means, which allows a loose movement of the optical element if a force is exerted on the optical element in the direction of the microscope. This means that the positioning device, or safety means, can be formed in such a way that, in the event of an exertion of force on the optical element, for example, caused by a collision with the eye in question, the optical element can be moved, essentially without resistance, in the direction of the objective lens. The safety means may thus be formed in such a way that the positioning device and the optical unit, owing to their respective inherent weight, hold the optical element in a lower position in the vicinity of the eye. If a force is then applied to the optical element in the direction of the microscope, merely a weight of the optical unit and positioning device is to be overcome to move the optical element. In particular by use of the double rocker mechanisms, a jamming of the safety means in relation to a linear guide can thus be prevented. Furthermore, with a use of plastics material for the relevant components, a weight thereof is comparatively low so that only a small force has to be applied to move the optical element. If the weight is reduced to such an extent that an undesired movement of the optical element can also no longer be excluded, a spring may be provided on the positioning device to stabilise the optical element and applies an additional force in the direction of the eye.

The positioning unit may advantageously comprise an alternating device, by means of which the optical element can be moved into and out of the beam path. The alternating device may be formed in such a way that the optical element can be slid or pivoted into the beam path. The optical element may preferably be pivoted about an axis extending transverse to the beam path, together with the positioning unit. It can thus be ensured that, during an operation, the positioning unit and the optical unit do not restrict or impair a view in an area of movement of the person carrying out the operation above the eye in question. It is thus also possible to move the optical element into and out of the beam path in a simple manner as required.

The alternating device may be formed by the connection device and the positioning device in such a way that the positioning device is pivotable relative to the connection device. Alternatively, the positioning device may be connected directly to the connection device so that it can be moved or pivoted relative to the connection device. Additional components are not necessarily required to form such an alternating device.

The connection device may also be formed of a plastics material. The connection device may be formed so as to be directly rigidly connectable to the microscope, or alternatively with an adapter means, which is in turn connected rigidly to the microscope. In this case, the connection device may be connected to the adapter means, for example, in the manner of a plug-in connection, without the aid of an additional tool. If an adapter means is provided on the microscope, this may, of course, also be formed of a plastics material.

The alternating device can be produced in a particularly simple manner if the alternating device is formed as a hinge, wherein the alternating device may comprise at least one snap-in means, by means of which the optical element is adjustable in a use position in the beam path and/or in an idle position outside the beam path. The hinge may be formed between the connection device and the positioning device so that it is possible to pivot the positioning device relative to the connection device. Furthermore, the snap-in means may be formed on the connection device and the positioning device and may, in turn, be formed of a locking lug and locking indentations for engagement with the locking lug. The locking lug and the locking indentations may each be moulded integrally on the connection device or the positioning device. The locking indentations may be arranged so that the locking lug engages in a locking indentation both in the use position and in the idle position, and the optical element and the positioning device can thus be locked in place.

The positioning unit can be produced in a particularly cost-effective and simple manner if the positioning unit is formed completely of plastics material. The positioning unit may be formed of only a few components since it is possible, for example, in a plastics injection moulding process, to also produce spatially complex components, which could only be produced from metal at high cost. For example, a polyamide may be used as a plastics material, in particular, owing to its mechanical properties. It is thus also possible, after use, to feed the entire positioning unit to a contaminated special waste at no further cost.

The monitoring device, according to the invention, comprises a positioning unit according to the invention and at least one optical unit, wherein the optical unit comprises at least one optical element. The optical unit is thus a component of the monitoring device, which may comprise a plurality of optical units in alternative embodiments. The optical unit also comprises at least one optical element, such as a lens or a prism, wherein a plurality of optical elements may also be provided which form a group of lenses or prisms of the optical unit. With regard to the advantages of the monitoring device according to the invention, reference is made to the above descriptions of features of the positioning unit.

In order to form an easily operable connection between the positioning unit and the optical unit, the positioning unit may comprise a receiving device, by means of which the optical unit can be adapted to the positioning unit, wherein the optical unit may form a holding means for holding the optical element and connecting it to the receiving device. The receiving device makes it possible to form the optical unit separately from the positioning unit and, if required, to exchange the optical unit during an eye operation, for example, without having to replace the entire positioning unit. It is thus still down to the person carrying out the operation to supplement, as required, the positioning unit with the optical unit to form the monitoring device. In order to enable a standardised connection between the optical unit and the receiving device, the optical element(s) can be held by the holding means in the provided position, wherein the holding means may be formed connected to the receiving device of the positioning unit, for example, in the manner of a plug-in connection. Owing to this interface on the positioning unit, conventional optical units can also be adapted to the positioning unit.

Alternatively, the positioning unit may form a holding means for holding the optical element. Consequently, the optical element may be held directly by the positioning unit without having to form a receiving device on the positioning unit. In particular, if the positioning unit is formed of plastics material, the holding means can be moulded integrally on the positioning device so that, in order to assemble the optical element, this only has to be inserted into the holding means.

To ensure singular use of the monitoring device, the holding means and/or the receiving device and/or a connection device may comprise at least one connecting element, which is formed in such a way that it is destroyed upon separation of the holding means and receiving device and/or connection device and a microscope. In particular, if components made of plastics material are used to form the monitoring device, a sterilisation of the monitoring device, or of the plastics material components, is not possible and is also undesirable. It is consequently to be ensured that these components are not reused in further eye operations. A connecting element may, therefore, be provided on the holding means, the receiving device or the connection device and is formed, for example, in the manner of a snap-in element, which has an intended breaking point and which locks in place upon assembly of the components in such a way that disassembly is only possible with forcible destruction of the connecting element. Renewed assembly and use is thus made difficult or impossible. The destroyed connecting element, or the relevant component, can also be recognised by a user as already having been used and, therefore, as being unusable.

The monitoring device can also be produced in a yet more cost-effective manner if the optical unit is formed of plastics material. One or more optical elements of the optical unit can also be produced from plastics material of corresponding optical quality.

The optical unit may also be formed in one piece, in particular, if the holding means is formed of the same material as the optical element. The optical element may then be formed together with the holding means in an injection moulding or pressing process. The optical unit may, therefore, also be produced so cost effectively that a reuse thereof can be omitted.

The optical element may be formed as an ophthalmoscopy lens, which is used to monitor an ocular fundus. The optical element may also be formed as a reducing lens, which is used to adjust the beam path. The monitoring device may also comprise merely of an ophthalmoscopy lens or an ophthalmoscopy lens with a reducing lens as a further optical element of a further optical unit. Additional optical units for image reversal, and/or exchange, of two beam paths may thus also be provided. When using a plurality of optical units, it is also possible to combine on the positioning unit reusable, sterilisable optical units with non-reusable optical units made of plastics material.

Further advantageous embodiments of the monitoring device will become clear from the descriptions of features of the various embodiments discussed above, which refer back to device according to the first embodiment of the invention.

### BRIEF DESCRIPTION OF THE DRAWINGS

Preferred embodiments of the invention will be described hereinafter in greater detail with reference to the accompanying drawings, in which:

FIG. 1 is a perspective view of a monitoring device comprising a positioning unit in a lower working position, in accordance with the present invention;

FIG. 2 is a perspective view of the monitoring device comprising the positioning unit in an upper working position;

FIG. 3 is a perspective view of a detail of an adjustment means;

FIG. 4 is a rear, perspective view of the monitoring device from FIG. 1;

FIG. 5 is a perspective view of the monitoring device from FIG. 1 in an idle position;

FIG. 6 is a perspective view of a further monitoring device comprising a positioning unit, in accordance with the present invention;

FIG. 7 is a rear view of the monitoring device from FIG. 6.

### DETAILED DESCRIPTION OF THE INVENTION

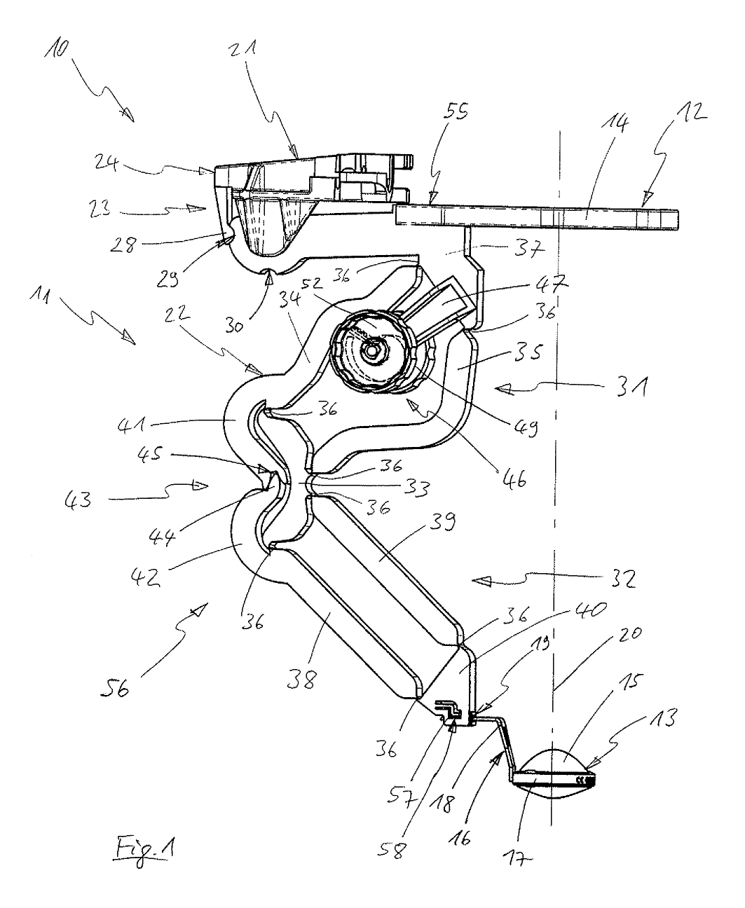

A monitoring device 10 comprising a positioning means 11 in various representations and positions can be derived by comparing FIGS. 1 to 5. The monitoring device 10 comprises optical units 12 and 13, wherein the optical unit 12 is only illustrated in part in this instance. Merely an annular holding means 14 of the optical unit 12, which annular holding means is used to receive a reducing lens (not shown here) is illustrated in this instance. The optical unit 13 is formed by an ophthalmoscopy lens 15 and a holding means 16. The holding means 16 comprises a mount for holding the ophthalmoscopy lens 15 and an angular holder 18 for connection to a receiving device 19 of the positioning means 11. The reducing lens (not shown in this instance) and the ophthalmoscopy lens 15 may be arranged in a beam path 20, illustrated suggestively in this instance, of a microscope (not shown in this instance).

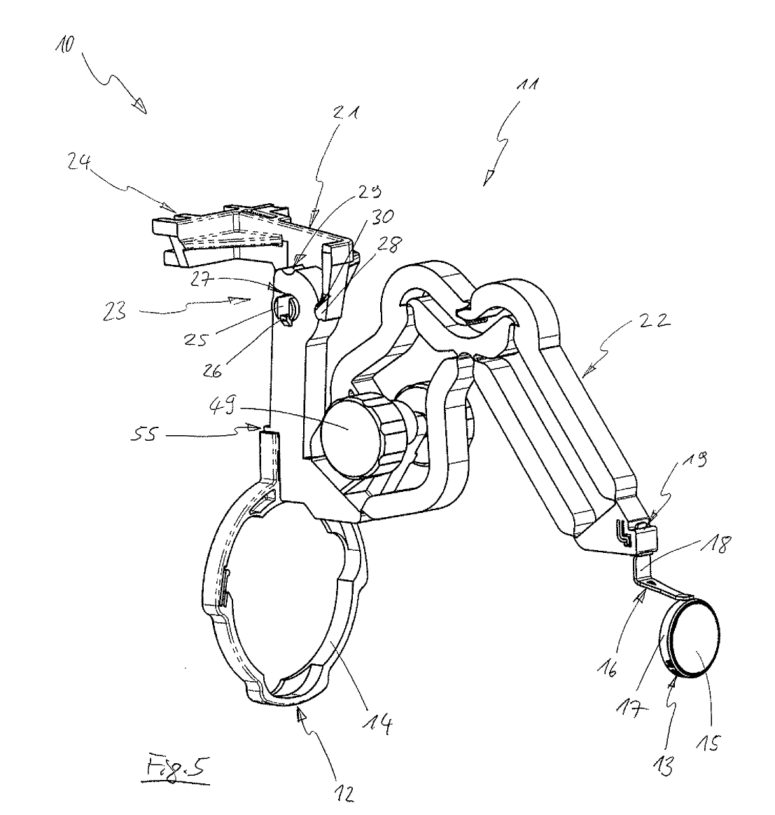

The positioning unit 11 comprises a connection device and a positioning device 22, wherein an alternating device 23 for pivoting the positioning device 22 with the optical units 12 and 13 out of and into the beam path 20 is formed between the connection device 21 and the positioning device 22, as can be seen by comparing FIGS. 1 and 5. The connection device 21 consists of a plastics material and is produced in one piece by an injection moulding process. Engagement elements 24 for connecting the connection device 21 to an adapter means (not shown in this instance) of a microscope are formed on the connection device 21. The connection device 21 further forms a shaft 25 having a locking lug 26, which can be inserted into a hub 27 of the positioning device 22 and can be locked in place as illustrated. The positioning device 22 can thus now be pivoted about the shaft 25. In addition, a further locking lug 28 is formed on the connection device 21 and can engage in locking indentations 29 and 30 in the positioning device 22. The locking indentations 29 and 30 are formed in the positioning device 22 in such a way that the positioning device 22 can be locked in place in the use position illustrated in FIG. 1, or in the idle position illustrated in FIG. 5, by engagement with the locking lug 28.

The positioning device 22 is formed of a first double rocker mechanism 31 and second double rocker mechanism 32. The double rocker mechanisms 31 and 32 are interconnected by means of a common coupling member 33. The first double rocker mechanism comprises a rocker 34 and a rocker 35, which are each connected via a living hinge 36 to the coupling member 33 and to a connecting bearing member 37. The second double rocker mechanism 32 comprises rockers 38 and 39, which are each connected by means of living hinges to the coupling member 33 and to a receiving bearing member 40. The rockers 34 and 38, or ends 41 and 42 formed thereon, further form a toothed gearing 43 with a tooth 44 and a tooth gap 45. A movement of the rockers 34 and 35 thus transfers the movement, by rolling the tooth 44 in the tooth gap 45, to the rockers 38 and 39 in a gear ratio in this instance of 1:1, and thus moves the ophthalmoscopy lens 15 along the beam path 20.

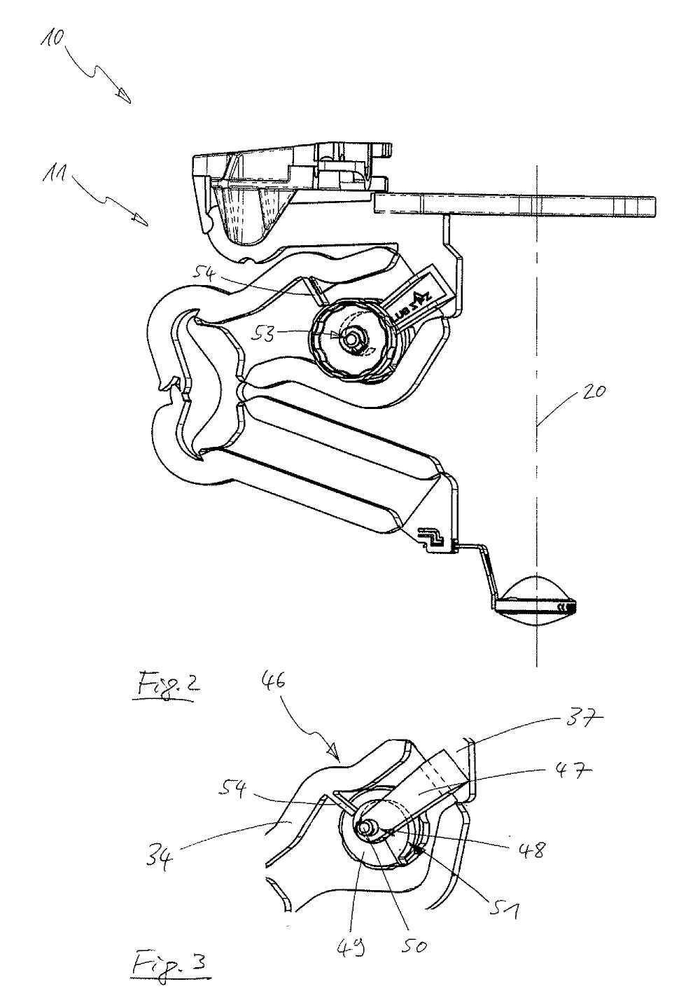

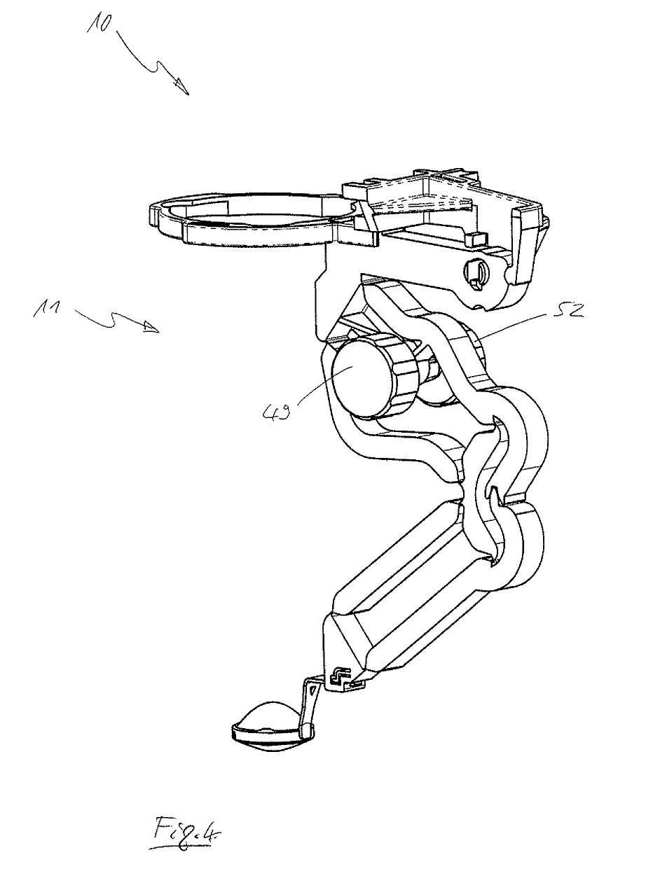

The positioning device 22 further comprises an adjustment means 46. As can be seen in greater detail from FIG. 3, the adjustment means 46 is formed of a holding element 47 moulded integrally on the connecting bearing member 37 and having a hub 48. An adjusting wheel 49 having a shaft 50 and a screw curve 51 moulded integrally on the adjusting wheel 49 is fitted on the hub 48. Opposite the adjusting wheel 49, a further adjusting wheel 52 having a hub 53, as can be seen, for example, from FIG. 1, is fitted on the shaft 50. A rotation of the adjusting wheels 49 or 52 now rolls the screw curve 51 over a cam 54, which is moulded integrally on the rocker 34. The rocker is thus movable relative to the connecting bearing member 37 so that the ophthalmoscopy lens 15 can be moved, by turning the adjusting wheels 49 and 52, from the lower working position shown in FIG. 1 into the upper working position shown in FIG. 2. The screw curve 51, or the adjusting wheel 49, is pressed against the cam 54 by the inherent weight of the double rocker mechanisms 31 and 32 as well as of the optical unit 13. If a force is exerted on the ophthalmoscopy lens 15 in the direction of the microscope (not shown in this instance), for example, by accidental contact between the ophthalmoscopy lens 15 and an eye to be operated on, the ophthalmoscopy lens 15, as illustrated in FIG. 2, can be moved into the upper working position against the aforementioned weight without a greater expenditure of force being necessary. The cam 54 can thus be easily removed or lifted off from the screw curve 51 without a further force having to be applied for this purpose. A safety means 56 thus formed may effectively prevent possible damage in the event of a collision with an eye.

In addition, the double rocker mechanisms 31 and 32 are formed in one piece together with the holding element 47 from a plastics material. The adjusting wheels 49 and 52 are each also formed of a plastics material. It is thus possible to produce the positioning unit 11 from merely four components that are made of plastics material, and can be easily plugged together. The holding means 14 is also formed of plastics material, wherein the holding means 16 consists of metal and is provided for sterilisation and reuse. The positioning device 22 further comprises a second receiving device 55 on the connecting bearing member 37, on which the annular holding means 14 can be fitted. Alternatively, it is possible to also use a holding means (not shown in this instance) and ophthalmoscopy lens made of plastics material. In order to ensure a secure hold of the holding means 16 in the receiving device 19, the receiving device 19 formed in the receiving bearing member 40 comprises two spring elements 57, which are each formed by a recess 58 and can be engaged with undercuts (not shown in this instance) in the holder 18. The spring elements 57 press from above onto the holder 18. The spring elements 57 are formed in such a way that they are destroyed when the holder 18 is removed from the receiving device 19. Only one individual spring element may also optionally be formed. It is thus clear to a user that the positioning unit 11 has already been used and cannot be reused.

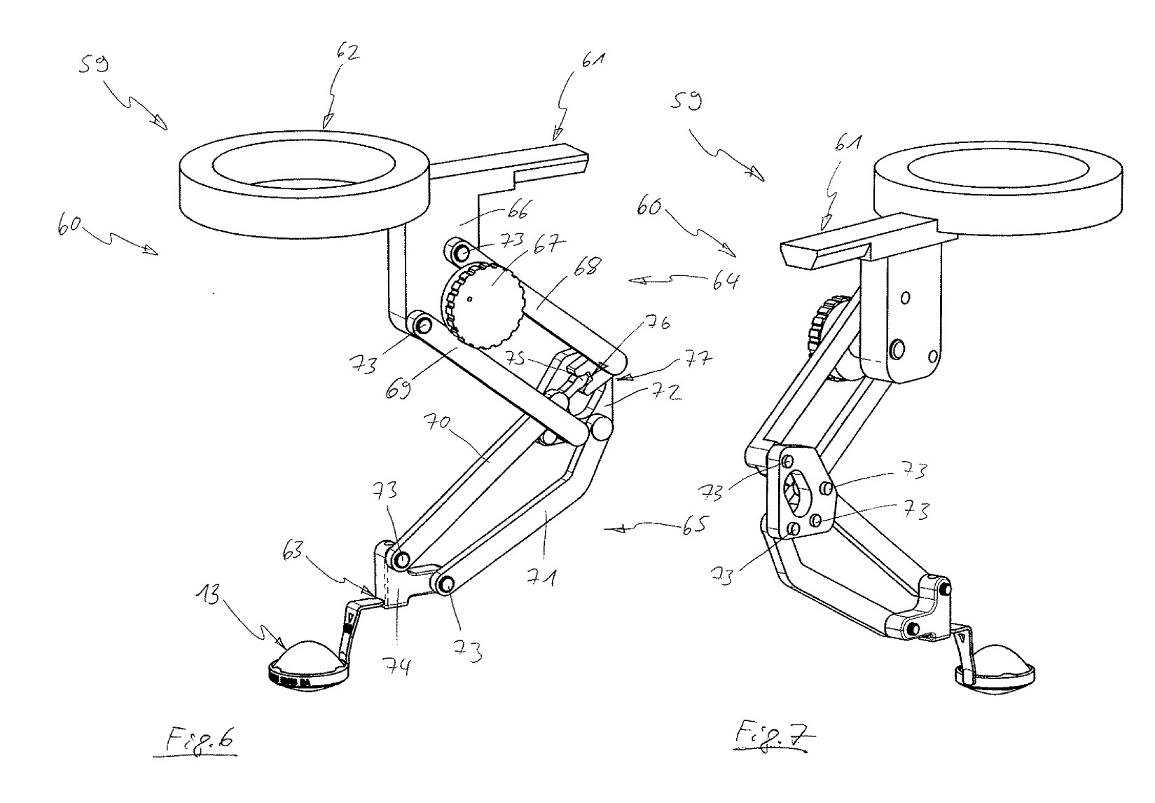

If FIGS. 6 and 7 are compared, a further monitoring device 59 comprising a positioning unit 60 and a connection device 61 on the positioning unit 60 is shown. A holding means 62 for receiving a reducing lens (not shown in this instance) is formed on the positioning unit 60. An optical unit 13, as illustrated in FIGS. 1 to 5, is also fitted on a connection device 63 of the positioning unit 60. In contrast to the positioning unit illustrated in FIGS. 1 to 5, in this case, a first double rocker mechanism 64 and a second double rocker mechanism 65 are formed in a number of parts. The first double rocker mechanism 64 comprises a connecting bearing member 66, on which an adjusting wheel is rotatably mounted, and rockers 68 and 69 which, similarly to rockers 70 and 71 of the second double rocker mechanism 65, are mounted rotatably on a coupling member 72 via pin connections 73 in each case. The rockers 70 and 71 are also connected rotatably to a receiving bearing member via the pin connections 73. A tooth 75 is formed on the rocker 70 and engages in a tooth gap 76 of the rocker 68, and thus forms a toothed gearing 77. A function of the double rocker mechanisms 64 and 65 with the adjusting wheel basically corresponds to the previously described function of the positioning unit from FIGS. 1 to 5. Owing to the simple shape of the components, the positioning unit 60 can also easily be formed of metal in a cost-effective manner, wherein, in this instance, too, the positioning unit 60 is formed predominantly of plastics material.

1. A positioning unit for positioning an optical unit comprising at least one optical element in a beam path of a microscope between an objective lens of the microscope and in front of an eye to be monitored, wherein the positioning unit comprises:
(a) a connection device , wherein the connection device operates to couple the positioning unit to the microscope, wherein the positioning unit is formed, at least in part, of plastics material.

2. The positioning unit according to claim 1, wherein the positioning unit further comprises:
(b) a positioning device operable to move the at least one optical element relative to the microscope in a longitudinal direction of the beam path.

3. The positioning unit according to claim 2, wherein the positioning unit includes a first double rocker mechanism and a second double rocker mechanism, wherein the first double rocker mechanism and the second double rocker mechanism are interconnected by a common coupling member.

4. The positioning unit according to claim 3, wherein link brackets of the first double rocker mechanism and the second double rocker mechanism are formed in each case by a living hinge.

5. The positioning unit according to claim 2, wherein the positioning device comprises an adjustment means that adjusts a position of the optical element.

6. The positioning unit according to claim 2, wherein the positioning device includes a safety means that allows a loose movement of the optical element when a force is exerted on the optical element in a direction of the microscope.

7. The positioning unit according to claim 2, wherein the positioning unit comprises an alternating device operable to move the optical element can be moved into and out of the beam path.

8. The positioning unit according to claim 7, wherein the alternating device includes the connection device and the positioning device, wherein the positioning device is pivotable relative to the connection device.

9. The positioning unit according to claim 7, wherein the alternating device comprises a hinge, and the alternating device further comprises at least one snap-in means operable to lock the optical element in a use position in the beam path, or to lock the optical element in an idle position outside the beam path, or to lock the optical element in the use position in the beam path and to lock the optical element in the idle position outside the beam path.

10. The positioning unit according to claim 1, wherein the positioning unit is formed completely of plastics material.

11. A monitoring device comprising:
i. a positioning unit according to claim 1; and
ii. at least one optical unit, wherein the optical unit comprises at least one optical element.

12. The monitoring device according to claim 11, wherein the positioning unit further comprises a receiving device that adapts the optical unit to the positioning unit, and the optical unit includes a holding means for holding the optical element and connecting the optical element to the receiving device.

13. The monitoring device according to claim 11, wherein the positioning unit comprises forms a holding means for holding the optical element.

14. The monitoring device according to claim 12, wherein the holding means, or the receiving device or the holding means and the receiving device, or a connection device, or the holding means and the receiving device and the connection device, comprises at least one connecting element that is formed so that the at least one connecting element is destroyed upon separation of the holding means and receiving device or the connection device and a microscope, or so that the at least one connecting element is destroyed upon separation of the holding means and receiving device and the connection device and the microscope.

15. The monitoring device according to claim 11, wherein the optical unit is formed of plastics material.

16. The monitoring device according to claim 11, wherein the optical unit is formed in one piece.

17. The monitoring device according to claim 11, wherein the optical element is ophthalmoscopy lens used to monitor an ocular fundus.

18. The monitoring device according to claim 11, wherein the optical element is a reducing lens that adjusts the beam path.

19. The positioning unit according to claim 3, wherein the positioning device comprises an adjustment means that adjusts a position of the optical element.

20. The positioning unit according to claim 4, wherein the positioning device comprises an adjustment means that adjusts a position of the optical element.
